(19) United States
(12) Patent Application Publication
(10) Pub. No.: US 2016/0045067 A1
(43) Pub. Date: Feb. 18, 2016

(54) Smokeless Barbecue Grill

(71) Applicant: Zhiwen LIAO, Guangdong Province (CN)

(72) Inventor: Zhiwen LIAO, Guangdong Province (CN)

(21) Appl. No.: 14/825,429

(22) Filed: Aug. 13, 2015

(30) Foreign Application Priority Data
Aug. 13, 2014 (CN) 201410398574.9

(51) Int. Cl. A47J 37/07

(52) U.S. Cl. CPC A47J 37/0754; A47J 37/0763

(57) ABSTRACT

A kind of smokeless barbecue grill, comprises a base and the case placed above the base, which is a hollow structure and above it there is a bracket containing a charcoal tray; one or more fans are arranged on the base; the fan of the barbecue grill is provided with one or more air ducts, which is tilted and bended and forms a certain angle with the longitudinal direction of the barbecue grill. This invention, by improving the above structure, effectively solves the problems with present technology such as non-uniform temperature, non-adjustable fire, and the heavy smoke due to insufficient burning of charcoal when the barbecue grill is working. The invention features the simple and reasonable structure, low manufacturing cost, uniform and adjustable fire, simple and easy operation, reliable performance, energy-saving and environmentally-friendliness, clean and sanitary, sufficient burning of charcoal and no smoke, and high thermal efficiency, so the user may truly realize smokeless barbecue, moreover, the main components made of stainless steel, are durable and strongly practical.

### TECHNICAL FIELD

The invention involves a barbecue grill, specifically, a smokeless barbecue grill.

### BACKGROUND TECHNOLOGY

The barbecue grill, also called baking oven, charcoal grill, refers to a device used to cook food with the heat generated from the burning of charcoal or pollution-free charcoal, usually an open or half-open structure. For the barbecue grill which cooks by means of air convection, the barbecue grill is usually provided with one or more heaters (charcoal braziers), and it heats air through the heater, and transfers the heat through the air convection to the food being cooked. However, owing to the unavoidable defect that during the process of energy transfer in the air, the temperature of the air close to the heater is higher while the temperature of the air far away from the heater is low, the barbecue grill always fails to efficiently and evenly cook the food and it will generate lots of oil smoke and dust, as well as the harmful gases caused by insufficient burning of charcoal such as carbon monoxide CO and smog, which impair the consumers' health and seriously pollute the environment.

To solve such defects as non-uniform temperature of cooking and large emission amount of smog, some existing barbecue grill cooks the food by arranging multiple heaters on two opposite sides of the cooking chamber, so as to increase the uniformity of heating. Moreover, to improve the uniformity of heating, some barbecue grill sets up the convection fans in the cooking chamber to accelerate the air convection and improve the uniformity of air distribution.

Although the existing barbecue grill solves the defects of non-uniformity of heating and large emission amount of smog to certain degree, its structure is complex, the production cost is high, and it cannot meet the users' use requirements. Therefore, it's necessary to make further improvement.

### CONTENT OF THE INVENTION

The invention aims to provide a smokeless barbecue grill with simple and reasonable structure, low manufacturing cost, uniform and adjustable fire, simple and easy operation, reliable performance, energy-saving and environmentally-friendliness, clean and sanitary, and high thermal efficiency and may realize a smokeless barbecue grill for smokeless barbecue, in order to overcome the shortcomings in existing technology.

A smokeless barbecue grill designed for the above purpose, comprising a base and the case placed above the base, is characterized in that: the case is a hollow structure and above it there is a bracket, containing a charcoal tray; one or more fans are arranged on the base; the fan of the barbecue grill is provided with one or more air ducts, which are tilted and bended and form a certain angle with the longitudinal direction of the barbecue grill.

A flash pan is arranged between the bracket and the charcoal tray, the fan is on the lower side of the flash pan, and is connected to the side of the flash pan through the tilted air duct, the wind generated by the fan enters the flash pan through the air duct, and forms the rotational wind in the flash pan.

Several air inlets are arranged in corresponding air duct of the bracket, the bearing part is arranged on the bracket, the charcoal tray is on the bearing part of bracket, and its bottom and the bottom of bracket form the flash pan.

The bottom air duct of the charcoal tray is arranged with several air vents, which are distributed in spiral shape, the rotational convex part, arranged at the bottom of the charcoal tray along the direction of rotational wind, is in the water drop shape with high inclination, low on the small end and high on the big end, and the convex height of one end is lower than the convex height of the other end; the air vents are arranged on the rotational convex part.

The fan obtains power supply from the dry battery, external power supply or their combination, and realizes wind control through mechanical control equipment or touch control equipment.

The fan obtains power supply from the dry battery, and realizes wind control through mechanical control equipment.

The mechanical control equipment contains the potentiometer switch knob on external wall of the case, the potentiometer switch is set on the potentiometer switch knob, and the potentiometer switch realizes electrically controlled connection with the fan through power line; a work indicator lamp is installed on the potentiometer switch knob.

A barbecue bracket or barbecue plate is placed on the bracket.

The invention, after improvement on the above structure, sets one or more fans on the base, the fan obtains the driving power supply from the dry battery, the potentiometer switch knob is set on the outer wall of case, and the fan adjusts the current through the potentiometer switch knob, so as to control the wind strength of the fan, thus greatly facilitating the user to use, meanwhile, since the fire is adjustable, the cooked food tastes better, has high nutritional content and is more healthy to eat; the air duct forms a certain angle with the longitudinal direction of the barbecue grill, the fan is placed on the lower side of the flash pan and is connected to the side of the flash pan through the tilted air duct, the wind generated by the fan enters the flash pan through the air duct, and forms the rotational wind in the flash pan, so as to make the burning of charcoal in the charcoal tray connected to the flash pan more sufficient and make the fire more fierce; moreover, the bottom air duct of the charcoal is arranged with several air vents, which are distributed in spiral shape, the rotational convex part, arranged at the bottom of the charcoal tray along the direction of rotational wind, and the rotational convex part is tilted, low in front end and high behind, and the convex height of one end is lower than the convex height of the other end, and the air vents are arranged on the rotational convex part, to make the air flow from the air duct smoother and form the rotational wind, and make the fire more uniform and make the burning of charcoal further more insufficient, thus reducing the emission of smog; and effectively solving the problems with present technology such as non-uniform temperature, non-adjustable fire, and the heavy smoke due to the insufficient burning of charcoal when the barbecue grill is working. The invention features the simple and reasonable structure, low manufacturing cost, uniform and adjustable fire, simple and easy operation, reliable performance, energy-saving and environmentally-friendliness, clean and sanitary, sufficient burning of charcoal and no smoke, and high thermal efficiency, so the user may truly realize smokeless barbecue, moreover, the main components made of stainless steel, are durable and strongly practical.

### DESCRIPTION OF THE DRAWINGS

FIG. 1 is the structure diagram of an example of the invention.

FIG. 2 is the structure diagram of a profile of an example of the invention.

FIG. 3 is the structure diagram of another profile of an example of the invention.

FIG. 4 is the structure diagram of bracket.

FIG. 5 and FIG. 6 are the structure diagram of charcoal tray.

### SPECIFIC IMPLEMENTATION METHOD

The following further describes the invention in combination with the drawings and examples.

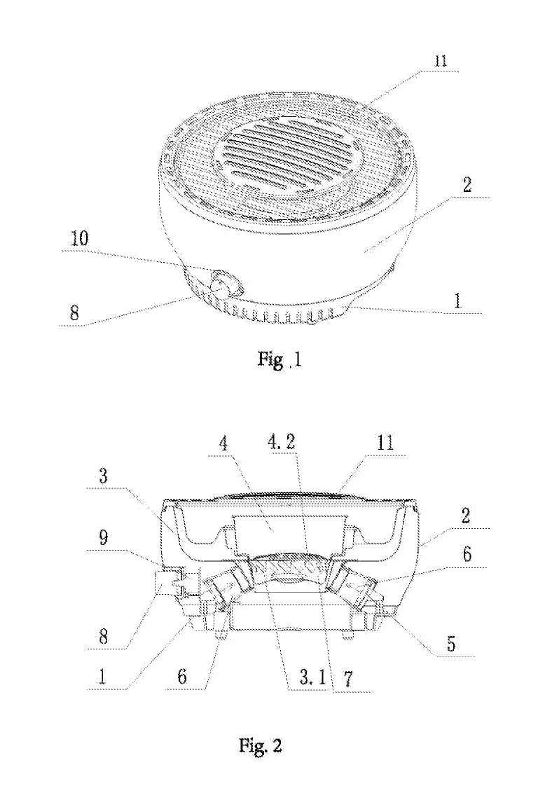

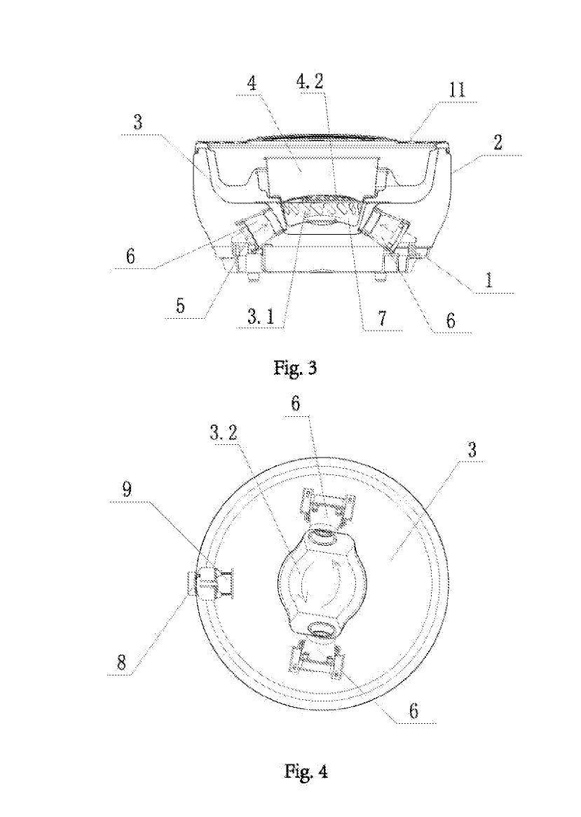

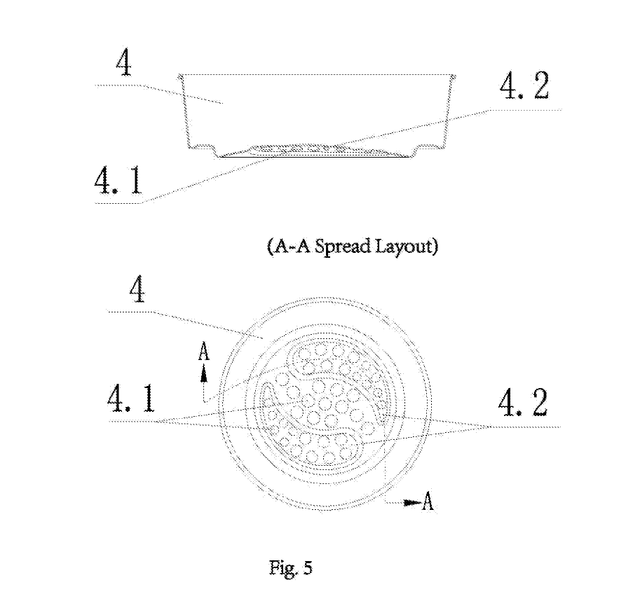

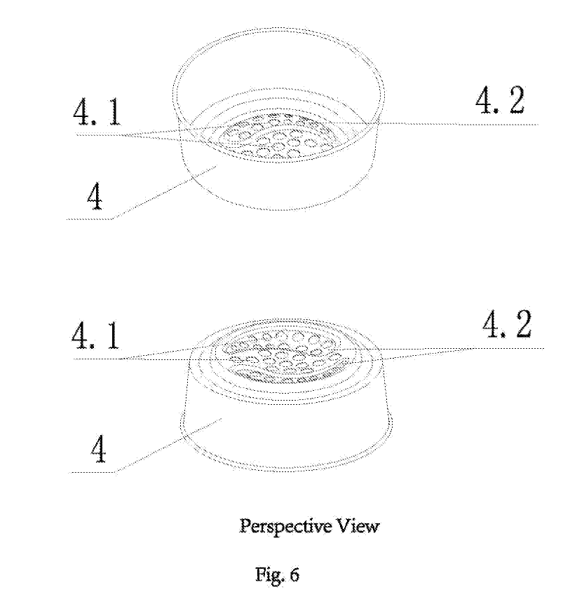

As shown in FIG. 1 to FIG. 6, the smokeless barbecue grill comprises a base 1 and the case 2 placed above the base 1, the case 2 is a hollow structure and above it there is a bracket 3 containing a charcoal tray 4; one or more fans 5 are arranged on the base 1; the fan 5 of the barbecue grill is provided with one or more air ducts 6, which are tilted and bended and form a certain angle with the longitudinal direction of the barbecue grill.

In the example, two fans 5 are arranged on the base 1, the fans 5 of the barbecue grill are provided with two air ducts 6, and the two fans 5 and air ducts 6 are arranged oppositely.

A flash pan 7 is arranged between the bracket 3 and the charcoal tray 4, the fan 5 is on the lower side of the flash pan 7, and is connected to the side of the flash pan 7 through the tilted air duct 6, the wind generated by the fan 5 enters the flash pan 7 through the air duct 6, and forms the rotational wind in the flash pan 7, thus making the charcoal in the charcoal tray 4 connected to the flash pan 7 burn more sufficiently and make the fire more fierce.

Several air inlets 3.1 are arranged in corresponding air duct 6 of the bracket 3, the air inlet 3.1 may be arranged on the wall of bracket 3, or on the bottom of the bracket 3; the bearing part 3.2 is also arranged on the bracket 3, and the charcoal tray 4 is on the bearing part 3.2 of bracket 3, and its bottom and the bottom of bracket 3 form the flash pan 7.

The bottom air duct 6 of the charcoal tray 4 is arranged with several air vents 4.1, the air vents 4.1 are distributed in spiral shape, the rotational convex part 4.2, arranged at the bottom of the charcoal pan 4 along the direction of rotational wind, is in the water drop shape with high inclination, low on the small end and high on the big end, and the convex height of one end is lower than the convex height of the other end, and the air vents 4.1 are arranged on the rotational convex part 4.2; the air from the air duct 6 flows smoother through the air vents 4.1 and the convex part 4.2, and forms the rotational wind, thus making the wind more uniform and make the charcoal burn more sufficient, so as to reduce the emission of smog.

In the above structure, the fan 5 obtains power supply from the dry battery, external power supply or their combination and realizes wind control through mechanical control equipment or touch control equipment, thus greatly facilitating the user to use, meanwhile, since the fire is adjustable, the cooked food tastes better, has high nutritional content and is more healthy to eat.

Specifically, the fan obtains power supply from the dry battery, and realizes wind control through mechanical control equipment. The mechanical control equipment contains the potentiometer switch knob 8 on external wall of the case 2, the potentiometer switch 9 is set on the potentiometer switch knob 8, and the potentiometer switch 9 realizes electrically controlled connection with the fan 5 through power line; a work indicator lamp 10 is installed on the potentiometer switch knob 8, to facilitate the user to observe the working state of the barbecue grill.

A barbecue bracket or barbecue plate 11 is placed on the bracket 3.

To extend the service life of the barbecue grill, the above main components made of stainless steel, are durable.

The above describes the optimized scheme of the invention, and its simple modification or alteration by ordinary technicians of the field all falls within the protection range of the invention.

1. A kind of smokeless barbecue grill, comprising a base (1) and the case (2) placed above the base (1), is characterized in that the case (2) is a hollow structure and above it there is a bracket (3), and the bracket (3) contains a charcoal tray (4); one or more fans (5) are arranged on the base (1); the fan (5) for the barbecue grill is provided with one or more air ducts (6), which(6) are tilted and bended and forms a certain angle with the longitudinal direction of the barbecue grill.

2. The smokeless barbecue grill, according to claim 1, is characterized in that a flash pan (7) is arranged between the bracket (3) and the charcoal tray (4), the fan (5) is on the lower side of the flash pan (7), and is connected to the side of the flash pan (7) through the tilted air duct (6), the wind generated by the fan (5) enters the flash pan (7) through the air duct (6), and forms the rotational wind in the flash pan (7).

3. The smokeless barbecue grill, according to claim 2, is characterized in that several air inlets (3.1) are arranged in corresponding air duct (6) of the bracket (3), the bearing part (3.2) is arranged on the bracket (3), the charcoal tray (4) is on the bearing part (3.2) of bracket (3), and its bottom and the bottom of bracket (3) form the flash pan (7).

4. The smokeless barbecue grill, according to claim 3, is characterized in that the bottom flash pan (7) of the charcoal tray (4) is arranged with several air vents (4.1), the air vents (4.1) are distributed in spiral shape, the rotational convex part (4.2), arranged at the bottom of the charcoal tray (4) along the direction of rotational wind, is in the water drop shape with high inclination, low on the small end and high on the big end, and the convex height of one end is lower than the convex height of the other end; the air vents (4.1) are arranged on the rotational convex part (4.2).

5. The smokeless barbecue grill, according to claim 4, is characterized in that the fan (5) obtains power supply from the dry battery, external power supply or their combination, and realizes wind control through mechanical control equipment or touch control equipment.

6. The smokeless barbecue grill, according to claim 5, is characterized in that the fan (5) obtains power supply from the dry battery, and realizes wind control through mechanical control equipment.

7. The smokeless barbecue grill, according to claim 6, is characterized in that the mechanical control equipment contains the potentiometer switch knob (8) on external wall of the case (2), the potentiometer switch (9) is set on the potentiometer switch knob (8), and the potentiometer switch (9) realizes electrically controlled connection with the fan (5) through power line; a work indicator lamp (10) is installed on the potentiometer switch knob (8).

8. The smokeless barbecue grill, according to claim 7, is characterized in that a barbecue bracket or barbecue plate (11) is placed on the bracket (3).
